(19) United States
(12) Patent Application Publication
(10) Pub. No.: US 2008/0249858 A1
(43) Pub. Date: Oct. 9, 2008

(54) AUTOMATICALLY GENERATING AN OPTIMAL MARKETING MODEL FOR MARKETING PRODUCTS TO CUSTOMERS

(76) Inventors: Robert Lee Angell, Salt Lake City, UT (US); James R. Kraemer, Santa Fe, NM (US)

Correspondence Address: DUKE W. YEE, YEE AND ASSOCIATES, P.C., P.O. BOX 802333, DALLAS, TX, 75380, US

(21) Appl. No.: 11/764,524

(22) Filed: Jun. 18, 2007

Related U.S. Application Data
(63) Continuation-in-part of application No. 11/695,983, filed on Apr. 3, 2007.

(51) Int. Cl. G06Q 30/00

(52) U.S. Cl. 705/14

(57) ABSTRACT

A computer implemented method, apparatus, and computer usable program code generating an optimized marketing model for marketing products to customers in a retail facility. In one embodiment, event data is parsed to identify patterns of events, wherein the event data comprises metadata describing events associated with the retail facility; events in the patterns of events that achieve a target outcome are identified to form optimized events. A marketing strategy is generated using the optimized events to form the optimized marketing model.

### CROSS-REFERENCE TO RELATED APPLICATIONS

This application is a continuation-in-part of patent application U.S. Ser. No. 11/695,983, filed Apr. 3, 2007, titled “Method and Apparatus for Providing Customized Digital Media Marketing Content Directly to a Customer”, which is incorporated herein by reference.

The present invention is also related to the following applications entitled Intelligent Surveillance System and Method for Integrated Event Based Surveillance, application Ser. No. 11/455,251 (filed Jun. 16, 2006); Retail Store Method and System, Robyn Schwartz, Publication No. US 2006/0032915 A1 (filed Aug. 12, 2004); and Business Offering Content Delivery, Robyn R. Levine, Publication No. US 2002/0111852 (filed Jan. 16, 2001) all assigned to a common assignee, and all of which are incorporated herein by reference.

### BACKGROUND OF THE INVENTION

1. Field of the Invention

The present invention is related generally to an improved data processing system and in particular to a method and apparatus for processing video and audio data. More particularly, the present invention is directed to a computer implemented method, apparatus, and computer usable program code for utilizing digital video modeling to generate an optimized marketing model for marketing products to customers based on patterns of events in a retail facility.

2. Description of the Related Art

In the past, merchants, such as store owners and operators, frequently had a personal relationship with their customers. The merchant often knew their customers' names, address, marital status, ages of their children, hobbies, place of employment, anniversaries, birthdays, likes, dislikes, personal preferences, and honesty of their customers. The merchant was able to use this information to cater to customer needs, push sales of items the customer might be likely to purchase based on the customer's personal situation, and develop an overall marketing strategy based on the merchants' knowledge of customer habits, preferences, and customer needs.

However, the continued growth of large cities, the corresponding disappearance of small, rural towns, and the increasing number of large, impersonal chain stores with multiple employees, the merchants and employees of retail businesses rarely recognize regular customers and almost never know the customer's name or any details regarding their customer's personal preferences that might assist the merchant or employee in marketing efforts.

One solution to this problem is directed toward using data mining techniques to gather customer profile data. The customer profile data is used to generate marketing strategies for marketing products to customers. Customer profile data typically includes information provided by the customer in response to a questionnaire or survey, such as the name, address, telephone number, and gender of customers, as well as products preferred by the customer. Demographic data regarding a customer's age, sex, income, career, interests, hobbies, and consumer preferences may also be included in customer profile data.

In an ideal situation, general marketing strategies may be made based on customer profiles and purchase trends. For example, if children tend to be the primary consumers of brightly colored, sugar coated cereals, these items may be placed on lower shelves so that they will be at a child's eye level. In another example, a manufacturer may pay the retail store owner or operator to place the item in a display at the end of an aisle or on a shelf at approximately eye level for an average shopper to generally increase the visibility and sales of the item.

However, these methods only provide limited and generalized marketing strategies that are directed towards a fairly large segment of the population without taking into account actual customer reactions to product placement in a particular retail store or to other environmental factors that may influence product purchases by customers.

In an attempt to better monitor customers in large retail stores, theses stores frequently utilize cameras and other audio and/or video monitoring devices to record customers inside the retail store or in the parking lot. A store detective may watch one or more monitors displaying closed circuit images of customers in various areas inside the store to identify shoplifters. However, these solutions require a human user to review the audio and video recordings. In addition, the video and audio recordings are typically used only for store security.

Thus, current solutions do not utilize all of the potential dynamic customer data elements that may be available for generating marketing strategies to optimize purchases by customers. The data elements currently being utilized to generate marketing strategies only provide approximately seventy-five percent (75%) of the needed customer data.

### SUMMARY OF THE INVENTION

The illustrative embodiments provide a computer implemented method, apparatus, and computer usable program code for generating an optimized marketing model for marketing items to customers in a retail facility. In one embodiment, event data is parsed to identify patterns of events. Parsing the event data may comprise processing the event data using at least one of a statistical method, a data mining method, a causal model, a mathematical model, a marketing model, a behavioral model, a psychological model, a sociological model, a simulation model, a market basket analysis, a segmentation model, and/or a k-means clustering algorithm.

The event data comprises metadata describing events associated with the retail facility; events in the patterns of events that achieve a target outcome are identified to form optimized events. The target outcome may include increasing sales of a set of items and/or increasing an amount of time a customer shops in the retail facility.

A marketing strategy is generated using the optimized events to form the optimized marketing model. In one embodiment, the optimized marketing model comprises a set of locations for a set of display devices associated with the retail facility. The set of display devices display customized marketing messages to customers.

In another embodiment, the optimized marketing model comprises a set of locations for placement of a set of items associated with the retail facility. The set of locations are locations for the set of items that will increase the likelihood that a customer will purchase an item in the set of items.

In another example, a smart detection engine receives video data from a set of cameras associated with the retail facility and analyzes the video data to form the event data. Analyzing the video data includes generating the metadata describing the events associated with the retail facility. In another example, analyzing the video data also includes receiving detection data from a set of detectors located inside the retail facility and/or outside the retail facility. The detection data is analyzed to form internal data and/or external data. In this example, the internal data and/or external data is processed with the video data to form the event data. The set of detectors associated with the retail facility may include a microphone, a pressure sensor, a device for detecting odors, a motion detector, and/or a thermal sensor.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a digital customer marketing environment in which illustrative embodiments may be implemented;

FIG. 3 is a block diagram of a data processing system in which illustrative embodiments may be implemented;

FIG. 4 is a diagram of a smart detection system in accordance with an illustrative embodiment of the present invention;

FIG. 5 is a block diagram of a data processing system for analyzing event data to identify event patterns for generating a marketing model in accordance with an illustrative embodiment;

FIG. 6 is a block diagram of a unifying data model for processing event data in accordance with an illustrative embodiment;

FIG. 7 is a flowchart illustrating a smart detection system generating event data in accordance with an illustrative embodiment; and

FIG. 8 is a flowchart illustrating a process for generating an optimized marketing model in accordance with an illustrative embodiment.

### DETAILED DESCRIPTION OF THE PREFERRED EMBODIMENT

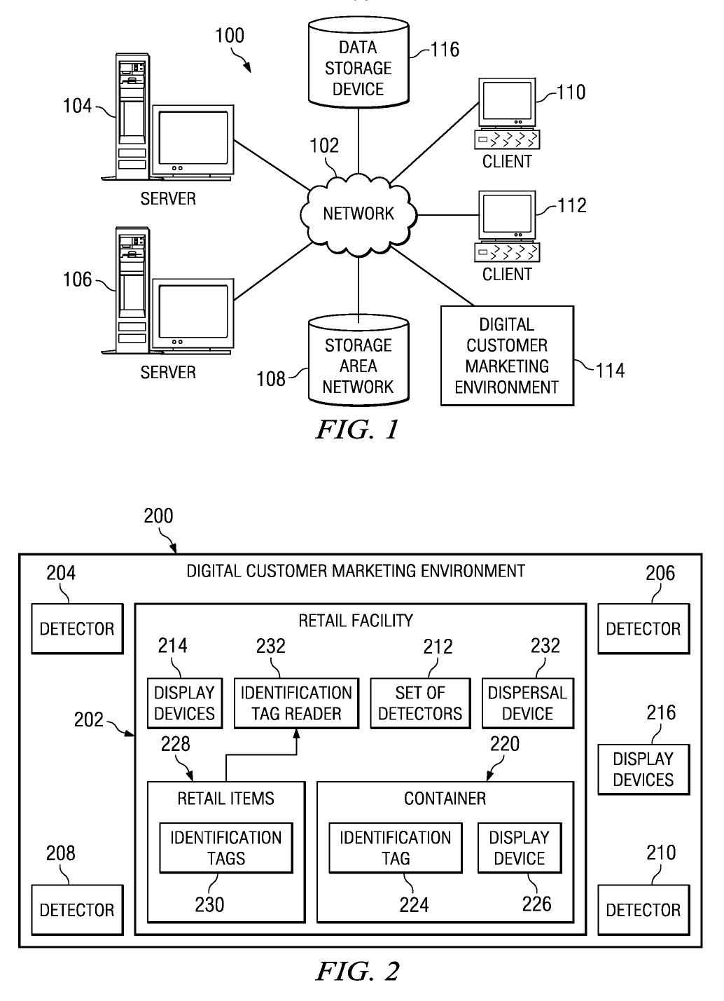

With reference now to the figures and in particular with reference to FIGS. 1-3, exemplary diagrams of data processing environments are provided in which illustrative embodiments may be implemented. It should be appreciated that FIGS. 1-3 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage area network (SAN) 108. Storage area network 108 is a network connecting one or more data storage devices to one or more servers, such as servers 104 and 106. A data storage device, may include, but is not limited to, tape libraries, disk array controllers, tape drives, flash memory, a hard disk, and/or any other type of storage device for storing data. Storage area network 108 allows a computing device, such as client 110 to connect to a remote data storage device over a network for block level input/output.

In addition, clients 110 and 112 connect to network 102. These clients 110 and 112 may be, for example, personal computers or network computers. In the depicted example, server 104 provides data, such as boot files, operating system images, and applications to clients 110 and 112. Clients 110 and 112 are clients to server 104 in this example.

Digital customer marketing environment 114 also connects to network 102. In addition to connecting to remote clients 110-112 and servers 104-106 through network 102, digital customer marketing environment 114 may also include one or more local computing devices, such as client 110 or server 104 located within digital customer marketing environment 114.

Digital customer marketing environment 114 is a marketing environment in which customers may view, select order, and/or purchase one or more items. Digital customer marketing environment 114 may include one or more facilities, buildings, or other structures for wholly or partially containing the items. A facility may include, but is not limited to, a grocery store, a clothing store, a marketplace, a retail department store, a convention center, a superstore, or any other type of structure for housing, storing, displaying, and/or selling items.

Items in digital customer marketing environment 114 may include, but are not limited to, comestibles, clothing, shoes, toys, cleaning products, household items, machines, any type of manufactured items, entertainment and/or educational materials, as well as entrance or admittance to attend or receive an educational or entertainment service, activity, or event. Items for purchase could also include services, such as, without limitation, ordering dry cleaning services, food delivery, or any other services.

Comestibles include solid, liquid, and/or semi-solid food and beverage items. Comestibles may be, but are not limited to, meat products, dairy products, fruits, vegetables, bread, pasta, pre-prepared or ready-to-eat items, as well as unprepared or uncooked food and/or beverage items. For example, a comestible could include, without limitation, a box of cereal, a steak, tea bags, a cup of tea that is ready to drink, popcorn, pizza, candy, or any other edible food or beverage items.

An entertainment or educational activity, event, or service may include, but is not limited to, a sporting event, a music concert, a seminar, a convention, a movie, a ride, a game, a theatrical performance, and/or any other performance, show, or spectacle for entertainment or education of customers. For example, entertainment or educational activity or event could include, without limitation, the purchase of seating at a football game, purchase of a ride on a roller coaster, purchase of a manicure, or purchase of admission to view a film.

Digital customer marketing environment 114 may also includes a parking facility for parking cars, trucks, motorcycles, bicycles, or other vehicles for conveying customers to and from digital customer marketing environment 114. A parking facility may include an open air parking lot, an underground parking garage, an above ground parking garage, an automated parking garage, and/or any other area designated for parking customers' vehicles.

For example, digital customer marketing environment 114 may be, but is not limited to, a grocery store, a retail store, a department store, an indoor mall, an outdoor mall, a combination of indoor and outdoor retail areas, a farmer's market, a convention center, a sports arena or stadium, an airport, a bus depot, a train station, a marina, a hotel, fair grounds, an amusement park, a water park, and/or a zoo.

Digital customer marketing environment 114 encompasses a range or area in which marketing messages may be transmitted to a digital display device for presentation to a customer within digital customer marketing environment. Digital multimedia management software is used to manage and/or enable generation, management, transmission, and/or display of marketing messages within digital customer marketing environment. Examples of digital multimedia management software includes, but is not limited to, Scala® digital media/digital signage software, EK3® digital media/digital signage software, and/or Allure digital media software.

Display devices may be located within digital customer marketing environment 114 in accordance with a marketing strategy or marketing model to increase the likelihood that a customer will view the marketing messages being displayed on a particular display device and/or increase the likelihood a customer will purchase an item. A marketing strategy is a set of one or more actions intended to increase the sales of one or more items to customers and/or increase the amount of time customers shop in digital customer marketing environment 114. In other words, a marketing strategy is an action intended to improve or increase sales to a group of two or more customers, rather than increase sales to one particular customer. A marketing model may include one or more marketing strategies.

Digital customer marketing environment 114 includes shelves, displays, racks, cases, refrigeration units, freezer units, hot boxes, and other containers for storing items. Items may be displayed on shelves, displays, racks, cases, refrigeration units, freezer units, hot boxes, and other containers as part of a marketing strategy. For example, items may be placed on a display at the end of an aisle as part of a marketing strategy to increase the likelihood that a group of customers will purchase the items.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as, without limitation, an intranet, an Ethernet, a local area network (LAN), and/or a wide area network (WAN).

Network data processing system 100 may also include additional data storage devices, such as data storage device 116. Data storage device 116 may be implemented in any type of device for storing data, including, without limitation, a hard disk, a compact disk (CD), a compact disk rewritable (CD-RW), a flash memory, a compact disk read-only memory (CD ROM), a non-volatile random access memory (NV-RAM), and/or any other type of storage device for storing data

FIG. 1 is intended as an example, and not as an architectural limitation for different embodiments. Network data processing system 100 may include additional servers, clients, data storage devices, and/or other devices not shown. For example, server 104 may also include devices not depicted in FIG. 1, such as, without limitation, a local data storage device. A local data storage device could include a hard disk, a flash memory, a non-volatile random access memory (NVRAM), a read only memory (ROM), and/or any other type of device for storing data.

A merchant, owner, operator, manager or other employee associated with digital customer marketing environment 114 typically wants to market products or services to customers or potential customers in the most convenient and efficient manner possible so as to maximize resulting purchases of goods and/or services by the customers. The aspects of the illustrative embodiments recognize that it is advantageous for the merchant to have a marketing model that takes into account as much information regarding customers as possible, including, without limitation, activities of customers in the retail facility and patterns of events occurring in a particular retail facility. This information permits a merchant to personalize the merchant's marketing strategy to those particular customers, customers' activities, and events.

Therefore, the illustrative embodiments provide a computer implemented method, apparatus, and computer usable program code for generating an optimized marketing model for marketing items to customers in a retail facility. In one embodiment, event data is parsed to identify patterns of events. The event data comprises metadata describing events associated with the retail facility. Events in the patterns of events that achieve a target outcome are identified to form optimized events. A marketing strategy is generated using the optimized events to form the optimized marketing model.

It will be appreciated by one skilled in the art that the words “optimize”, “optimization” and related terms are terms of art that refer to improvements in speed and/or efficiency of a computer program, and do not purport to indicate that a computer program has achieved, or is capable of achieving, an “optimal” or perfectly speedy/perfectly efficient state.

Event data is data and metadata describing events that occur inside a retail facility and/or outside the retail facility. For example, event data could include, but is not limited to, a location at which customers tend to congregate or loiter, a location at which customers tend to walk at a faster pace, a location on store shelves at which customers tend to linger or stare for a more prolonged period than other areas, an area of the store that customers tend to ignore or neglect, an area of the store in which customers frequently search for customer service or store employees to get assistance, an area of the store in which children tend to wait, play, dwell or loiter, and/or any other data describing events in the retail facility.

Event data is processed to generate an optimized marketing model. An optimized marketing model provides information, suggestions, and/or instructions for one or more marketing strategies. A marketing strategy includes an action intended to improve or increase the number of items purchased by a group of customers in the retail facility and/or increase the amount of time that the group of customers continue to shop and purchase items in the retail facility.

For example, the optimized marketing model may include an action to display a new product at the end of an aisle where the product will be more visible to customers, display an item on a shelf at eye level, play a particular type of music over a sound system, play music or other audio content at a particular volume over the sound system, adjust the lighting in an area of the retail facility to a particular brightness level, release a particular type and/or amount of an odor-causing chemical at a particular location in the retail facility, move a display device or store shelf to a particular location in the retail facility, and/or any other action to improve or optimize marketing efforts. An odor-causing chemical could include, without limitation, perfumes, artificial pheromones, natural scents, and/or artificial scents, such as, without limitation, the smell of popcorn.

Processing or parsing the event data to generate the optimized marketing model may include, but is not limited to, formatting the event data for utilization and/or analysis in one or more data models, combining the event data with external data and/or internal data, comparing the event data to a data model and/or filtering the event data for relevant data elements to form the dynamic data.

The event data may be processed with external data associated with a group of customers and/or internal data associated with the group of customers to form the dynamic data. External data is received from a set of detectors located externally to a retail facility to form external data. External data may include data captured by a set of motion detectors, sound detection devices, or pressure sensors or cameras. A group of customers may include one or more customers.

As used herein, the term “set” may also include one or more. For example, a set of motion detectors may include a single motion detector or two or more motion detectors. In one embodiment, the detectors include a set of one or more cameras located externally to the retail facility. Video images received from the set of cameras are used to identify a presence of a group of customers outside the retail facility. The video images from the set of cameras outside the retail facility are external data.

Internal data is data received from a set of detectors located internally or inside of a retail facility. For example, internal data may include, but is not limited to, video images of a group of customers captured by cameras located inside or internally to a retail facility and/or data regarding the current or real-time contents of a customer's shopping basket gathered by a set of radio frequency identification sensors located inside the retail facility.

As used herein, data associated with a customer may include data describing the customer, the customer's appearance, members of the customer's family, pets, cars or other vehicles belonging to the customer, the customer's shopping companions, the customer's friends, and/or any other data pertaining to the customer. The customized marketing message is delivered to a display device associated with the customer for display.

Dynamic data is data for a group of customers that is gathered and analyzed in real time as the customers are shopping or browsing in retail marketing environment 114.

Dynamic data may include, but is not limited to, data that has been processed or filtered for analysis in a data model. If the internal data includes video images of a customer inside a retail facility, the video images may need to be processed to convert the video images into data and/or metadata for analysis in a data model. For example, a data model may not be capable of analyzing raw, or unprocessed video images captured by a camera. The video images may need to be processed into data and/or metadata describing the contents of the video images before a data model may be used to organize, structure, or otherwise manipulate data and/or metadata. The video images converted to data and/or metadata that is ready for processing or analysis in a set of data models is an example of dynamic data.

The dynamic data is analyzed using one or more data models in a set of data models to identify patterns of events taking place in the retail facility. For example, a pattern of events may indicate that on a hot afternoon, customers tend to park on the south side of the retail facility's parking lot, which has more trees and covered parking spots rather than the west side of the parking lot that has greater exposure to the sun. Likewise, the event patterns may indicate that on hot afternoons, customers tend to slow their pace of walking or pause for a moment in the center of an aisle that is located underneath an air-conditioning vent.

The patterns of events may be further processed in one or more data models in the set of data models to generate the optimized marketing model. The optimized marketing model may include an optimized placement for one or more display devices. For example, if a display device is an electronic sign that is positioned on an exterior wall of the retail facility at the west entrance to the retail facility, the marketing model may suggest moving the electronic sign to the south entrance during summer months.

Likewise, if the patterns of events indicate customers tend to slow down or pause in the center of an aisle that is located underneath an air-conditioning vent during hot summer afternoons, the marketing model may suggest moving a display screen from the end of the aisle to the center of the aisle nearest to the air-conditioning vent so as to increase the likelihood that customers will view the marketing messages displayed on the display device.

A set of data models includes one or more data models. A data model is a model for structuring, defining, organizing, imposing limitations or constraints, and/or otherwise manipulating data and metadata to produce a result. A data model may be generated using any type of modeling method or simulation including, but not limited to, a statistical method, a data mining method, a causal model, a mathematical model, a marketing model, a behavioral model, a psychological model, a sociological model, or a simulation model.

In another embodiment, the dynamic data is analyzed using the set of data models to create specific and personalized marketing message criteria for a customer. A customized marketing message is generated using the personalized marketing message criteria. Personalized marketing message criteria are criterion or indicators for selecting one or more modular marketing messages for inclusion in the customized marketing message.

The personalized marketing message criteria may include one or more criterion. The personalized marketing message criteria may be generated, in part, a priori or pre-generated and in part dynamically in real-time based on the event data for the customer and/or any available external data and/or internal data associated with the customer. The personalized marketing message criteria may also be implemented completely dynamically based on the event data for the customer and/or any available external data and/or internal data associated with the customer.

A marketing message is a message that presents a message regarding a product or item that is being marketed, advertised, promoted, and/or offered for sale. A marketing message may include, but is not limited to, marketing messages displayed on a digital display device. A marketing message may include textual content, graphical content, moving video content, still images, audio content, and/or any combination of textual, graphical, moving video, still images, and audio content. A customized marketing message is a marketing message that is generated for a particular customer or group of customers based on one or more personalized message criteria for the customer.

The customized marketing message is a highly personalized marketing message for a specific or particular customer. The personalized marketing message may include special offers or incentives to the customer. An incentive is an offer of a discount or reward to encourage a customer to select, order, and/or purchase one or more items.

The display device for presenting the customized marketing message to the customer may be, without limitation, a kiosk, a personal digital assistant, a cellular telephone, a laptop computer, a display screen, an electronic sign or a smart watch. In another embodiment, the display device is located externally to the retail facility. The customized marketing message is displayed on the display device to the customer before the customer enters the retail facility. In another embodiment, the customized marketing message is displayed to the customer after the customer enters the retail facility and begins shopping.

FIG. 2 is a block diagram of a digital customer marketing environment in which illustrative embodiments may be implemented. Digital customer marketing environment 200 is a marketing environment, such as digital customer marketing environment 114 in FIG. 1.

Retail facility 202 is a retail facility for wholly or partially storing, enclosing, or displaying items for marketing, viewing, selection, order, and/or purchase by a customer. For example, retail facility 202 may be, without limitation, a retail store, supermarket, a big box store, a superstore, a book store, clothing store, or shopping mall. However, retail facility 202 is not limited to retail stores. For example, retail facility 202 may also include, without limitation, a sports arena, amusement park, water-park, convention center, or any other location at which items are sold or offered for sale to customers. In this example, retail facility 202 is a grocery store.

Detectors 204-210 are devices for gathering data associated with a set of one or more customers. Detectors 204-210 are examples of detectors that are located externally to retail facility 202. In this example, detectors 204-210 are located at locations along an outer perimeter of digital customer marketing environment 200. However, detectors 204-210 may be located at any position within digital customer marketing environment 200 that is outside retail facility 202 to detect customers before the customers enter retail facility 202 and/or after customers leave digital customer marketing environment 200. For example, detectors 204-210 may be mounted to light poles in a parking lot, above a doorway or entrance to retail facility 202, or mounted to a roof of retail facility 202.

Detectors 204-210 may be any type of detecting devices for gathering data associated with a customer, including, but not limited to, a camera, a motion sensor device, a sonar, sound recording device, audio or ultrasound detection device, a voice recognition system, a heat sensor, a seismograph, a pressure sensor, a device for detecting odors, scents, and/or fragrances, a radio frequency identification (RFID) tag reader, a global positioning system (GPS) receiver, and/or any other detection device for detecting a presence of a human, animal, and/or conveyance vehicle outside of the retail facility. A conveyance vehicle is a vehicle for conveying people, animals, or objects to a destination. A conveyance vehicle may include, but is not limited to, a car, bus, truck, motorcycle, boat, airplane, moped, or any other type of vehicle.

Detectors 204-210 may be used to gather external data associated with a group of customers. External customer data is data for detecting a presence of a group of customers outside retail facility 202. External data may be gathered by detection devices such as, without limitation, a camera, an audio recorder, a sound detection device, a seismograph, pressure sensors, a device for detecting odors, scents, and/or fragrances, a motion detector, a thermal sensor or other heat sensor device, and/or any other device for detecting a presence of a human, animal, and/or conveyance vehicle outside of the retail facility.

A heat sensor may be any type of known or available sensor for detecting body heat generated by a human or animal. A heat sensor may also be a sensor for detecting heat generated by a vehicle, such as an automobile or a motorcycle.

A motion detector may include any type of known or available motion detector device. A motion detector device may include, but is not limited to, a motion detector device using a photo-sensor, radar or microwave radio detector, or ultrasonic sound waves.

A motion detector using ultrasonic sound waves transmits or emits ultrasonic sounds waves. The motion detector detects or measures the ultrasonic sound waves that are reflected back to the motion detector. If a human, animal, or other object moves within the range of the ultrasonic sound waves generated by the motion detector, the motion detector detects a change in the echo of sound waves reflected back. This change in the echo indicates the presence of a human, animal, or other object moving within the range of the motion detector.

In one example, a motion detector device using a radar or microwave radio detector may detect motion by sending out a burst of microwave radio energy and detecting the same microwave radio waves when the radio waves are deflected back to the motion detector. If a human, animal, or other object moves into the range of the microwave radio energy field generated by the motion detector, the amount of energy reflected back to the motion detector is changed. The motion detector identifies this change in reflected energy as an indication of the presence of a human, animal, or other object moving within the motion detectors range.

A motion detector device, using a photo-sensor, detects motion by sending a beam of light across a space into a photo-sensor. The photo-sensor detects when a human, animal, or object breaks or interrupts the beam of light by moving in-between the source of the beam of light and the photo-sensor. These examples of motion detectors are presented for illustrative purposes only. A motion detector in accordance with the illustrative embodiments may include any type of known or available motion detector and is not limited to the motion detectors described herein.

A pressure sensor detector may be, for example, a device for detecting a change in weight or mass associated with the pressure sensor. For example, if one or more pressure sensors are imbedded in a sidewalk, Astroturf, or floor mat, the pressure sensor detects a change in weight or mass when a human customer or animal steps on the pressure sensor. The pressure sensor may also detect when a human customer or animal steps off of the pressure sensor. In another example, one or more pressure sensors are embedded in a parking lot, and the pressure sensors detect a weight and/or mass associated with a vehicle when the vehicle is in contact with the pressure sensor. A vehicle may be in contact with one or more pressure sensors when the vehicle is driving over one or more pressure sensors and/or when a vehicle is parked on top of one or more pressure sensors.

A camera may be any type of known or available camera, including, but not limited to, a video camera for taking moving video images, a digital camera capable of taking still pictures and/or a continuous video stream, a stereo camera, a web camera, and/or any other imaging device capable of capturing a view of whatever appears within the camera's range for remote monitoring, viewing, or recording of a distant or obscured person, object, or area.

Various lenses, filters, and other optical devices such as zoom lenses, wide angle lenses, mirrors, prisms and the like may also be used with image capture device to assist in capturing the desired view. Device 12 may be fixed in a particular orientation and configuration, or it may, along with any optical devices, be programmable in orientation, light sensitivity level, focus or other parameters. Programming data may be provided via a computing device, such as server 104 in FIG. 1.

A camera may also be a stationary camera and/or non-stationary cameras. A non-stationary camera is a camera that is capable of moving and/or rotating along one or more directions, such as up, down, left, right, and/or rotate about an axis of rotation. The camera may also be capable of moving to follow or track a person, animal, or object in motion. In other words, the camera may be capable of moving about an axis of rotation in order to keep a customer, animal, or object within a viewing range of the camera lens. In this example, detectors 204-210 are non-stationary digital video cameras.

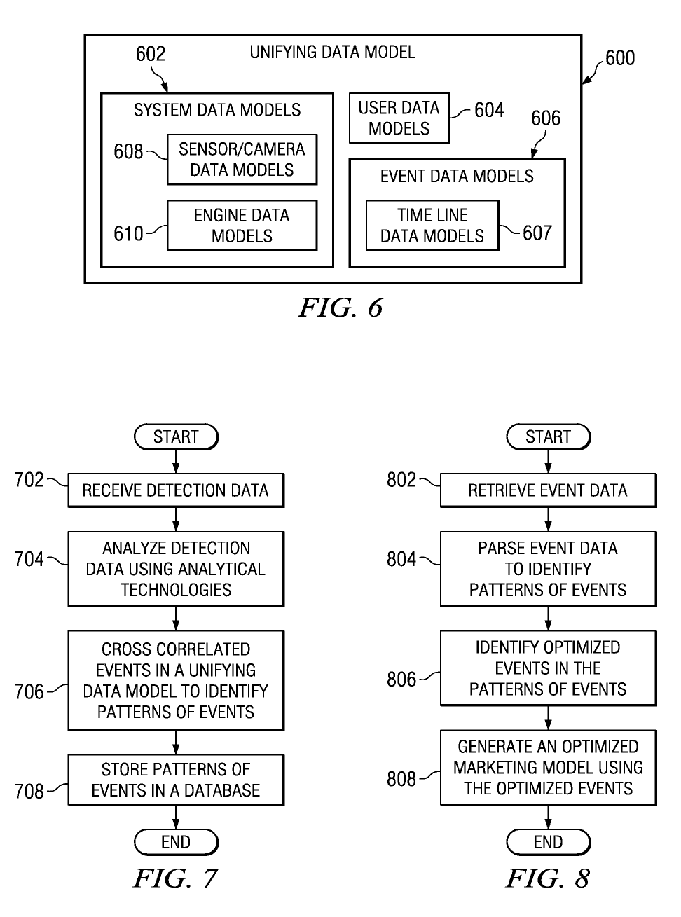

Detectors 204-210 are connected to an analysis server on a data processing system, such as network data processing system 100 in FIG. 1. The analysis server is illustrated and described in greater detail in FIG. 6 below. The analysis server includes software for analyzing digital images and other data captured by detectors 204-210 to track and/or visually identify retail items, containers, and/or customers outside retail facility 202. Attachment of identifying marks may be part of this visual identification in the illustrative embodiments.

Detectors 204-210 may also be used to gather audio and/or video data associated with a group of one or more customers for processing into event data. The audio and/or video data is sent to smart detection software. The smart detection software processes the audio and/or video data to form the event data. The event data includes data and metadata describing events captured on the audio or video data. The event data is sent to the analysis server for additional processing to identify patterns of events in the events. For example, event data may describe a first customer pausing beneath an air-conditioning vent, a second customer slowing their pace at the same location, a third customer continuing down the aisle at a constant pace, and a fourth customer significantly slowing down at the same location. The analysis server analyzes these events to identify a pattern of events indicating that customers tend to slow down or pause at the location beneath the air-conditioning vent.

In this example, four detectors, detectors 204-210, are located outside retail facility 202. However, any number of detectors may be used to detect, track, and/or gather data associated with customers outside retail facility 202. For example, a single detector, as well as two or more detectors may be used outside retail facility 202 for tracking customers entering and/or exiting retail facility 202.

Retail facility 202 may also optionally include set of detectors 212. Set of detectors 212 is a set of one or more detectors for gathering data associated with a set of customers located inside of retail facility 202. In this example, set of detectors 212 gathers audio and/or video data associated with a group of customers for processing into event data. Set of detectors 212 may also optionally be used to gather internal data for a group of customers.

Set of detectors 212 may be located at any location within retail facility 202. In addition, set of detectors 212 may include multiple detectors located at differing locations within retail facility 202. For example, a detector in set of detectors 212 may be located, without limitation, at an entrance to retail facility 202, on one or more shelves in retail facility 202, and/or on one or more doorways in retail facility 202.

The detectors in set of detectors 212 may be any type of detecting devices. In this example, set of detectors 212 may include one or more cameras or other image capture devices located inside retail facility 202 for gathering the audio and/or video associated with the group of customers.

In another embodiment, set of detectors 212 may also include detectors for gathering internal data associated with the group of customers, including, without limitation, motion sensor devices, sonar detectors, sound recording devices, audio detection devices, voice recognition systems, heat sensors, seismographs, pressure sensors, devices for detecting odors, scents, and/or fragrances, radio frequency identification (RFID) tag readers, global positioning system (GPS) receivers, and/or any other detection devices for detecting humans, animals, and/or conveyance vehicles inside of retail facility 202. In this example, detectors in set of detectors 212 are used for tracking and/or identifying items, containers for items, shopping containers and shopping carts, and/or customers inside retail facility 202 to form internal data.

The camera or other detector in set of detectors 212 may be coupled to and/or in communication with the analysis server. In addition, more than one image capture device may be operated simultaneously without departing from the illustrative embodiments of the present invention.

Display devices 214 are multimedia devices for displaying marketing messages to customers. Display devices 214 may be any type of display device for presenting a text, graphic, audio, video, and/or any combination of text, graphics, audio, and video to a customer. For example, display devices 214 may be, without limitation, a computer display screen, laptop computer, a tablet personal computer (PC), a video display screen, a digital message board, a monitor, a kiosk, a personal digital assistant (PDA), and/or a cellular telephone with a display screen. Display devices 214 may be one or more display devices located within retail facility 202 for use and/or viewing by one or more customers.

In this example, display devices 214 are located inside retail facility 202. However, display devices 214 may also be located outside retail facility, such as display devices 216. In this example, display devices 216 is one or more display devices, such as display screens, electronic signs, PDAs, or kiosks, located in a parking lot, queue line, or other area outside of retail facility 202. Display devices 216 outside retail facility 202 may be used in the absence of display devices 214 inside retail facility 202 or in addition to display devices 214 located inside retail facility 202.

Container 220 is a container for holding, carrying, transporting, or moving one or more items. For example, container 220 may be, without limitation, a shopping cart, a shopping bag, a shopping basket, and/or any other type of container for holding items. In this example, container 220 is a shopping cart.

In this example in FIG. 2, only one container 220 is depicted inside retail facility 202. However, any number of containers may be used inside and/or outside retail facility 202 for holding, carrying, transporting, or moving items selected by customers.

Container 220 may also optionally include identification tag 224. Identification tag 224 is a tag for identifying container 220, locating container 220 within digital customer marketing environment 200, either inside or outside retail facility 202, and/or associating container 220 with a particular customer. For example, identification tag 224 may be a radio frequency identification (RFID) tag, a universal product code (UPC) tag, a global positioning system (GPS) tag, and/or any other type of identification tag for identifying, locating, and/or tracking a container.

Container 220 may also include display device 226 coupled to, mounted on, attached to, or imbedded within container 220. Display device 226 is a multimedia display device for displaying textual, graphical, video, and/or audio marketing messages to a customer. For example, display device 226 may be a digital display screen or personal digital assistant attached to a handle, front, back, or side member of container 220. Display device 226 may be operatively connected to a data processing system, such as data processing system 100 connected to digital customer marketing environment 114 in FIG. 1 via wireless, infrared, radio, or other connection technologies known in the art, for the purpose of transferring data to be displayed on display device 226. The data processing system includes the analysis server for analyzing dynamic external customer data obtained from detectors 204-210 and set of detectors 212, as well as internal customer data obtained from one or more databases storing data associated with one or more customers.

Retail items 228 are items of merchandise for sale. Retail items 228 may be displayed on a display shelf (not shown) located in retail facility 202. Other items of merchandise that may be for sale, such as food, beverages, shoes, clothing, household goods, decorative items, or sporting goods, may be hung from display racks, displayed in cabinets, on shelves, or in refrigeration units (not shown). Any other type of merchandise display arrangement known in the retail trade may also be used in accordance with the illustrative embodiments.

For example, display shelves or racks may include, in addition to retail items 228, various advertising displays, images, or postings. A multimedia display device attached to a data processing system may also be included. The images shown on the multimedia display may be changed in real time in response to various events such as the time of day, the day of the week, a particular customer approaching the shelves or rack, or items already placed inside container 220 by the customer.

Retail items 228 may be viewed or identified using an image capture device, such as a camera or other detector in set of detectors 212. To facilitate such viewing, an item may have attached identification tags 230. Identification tags 230 are tags associated with one or more retail items for identifying the item and/or location of the item. For example, identification tags 230 may be, without limitation, a bar code pattern, such as a universal product code (UPC) or European article number (EAN), a radio frequency identification (RFID) tag, or other optical identification tag, depending on the capabilities of the image capture device and associated data processing system to process the information and make an identification of retail items 228. In some embodiments, an optical identification may be attached to more than one side of a given item.

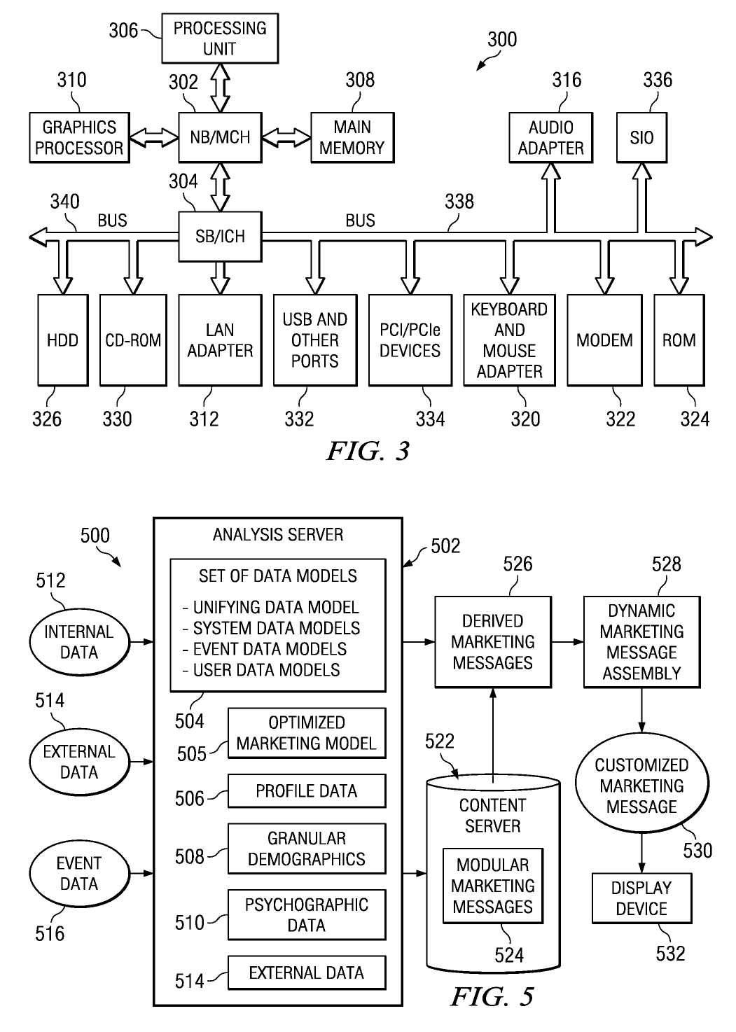

The data processing system, discussed in greater detail in FIG. 3 below, includes associated memory which may be an integral part, such as the operating memory, of the data processing system or externally accessible memory. Software for tracking objects may reside in the memory and run on the processor. The software is capable of tracking retail items 228, as a customer removes an item in retail items 228 from its display position and places the item into container 220. Likewise, the tracking software can track items which are being removed from container 220 and placed elsewhere in the retail store, whether placed back in their original display position or anywhere else including into another container. The tracking software can also track the position of container 220 and the customer.

The software can track retail items 228 by using data from one or more of detectors 204-210 located externally to retail facility, internal data captured by one or more detectors in set of detectors 212 located internally to retail facility 202, such as identification data received from identification tags 230 and/or identification data received from identification tag 224. The software in the data processing system keeps a list of which items have been placed in each shopping container, such as container 220. The list is stored in a database. The database may be any type of database such as a spreadsheet, relational database, hierarchical database or the like. The database may be stored in the operating memory of the data processing system, externally on a secondary data storage device, locally on a recordable medium such as a hard drive, floppy drive, CD ROM, DVD device, remotely on a storage area network, such as storage area network 108 in FIG. 1, or in any other type of storage device.

The lists of items in container 220 are updated frequently enough to maintain a dynamic, accurate, real time listing of the contents of each container as customers add and remove items from containers, such as container 220. The listings of items in containers are also made available to whatever inventory system is used in retail facility 202. Such listings represent an up-to-the-minute view of which items are still available for sale, for example, to on-line shopping customers. The listings may also provide a demand side trigger back to the supplier of each item. In other words, the listing of items in customer shopping containers can be used to update inventories to determine current stock available for sale to customers and/or identification of items that need to be restocked or replenished.

At any time, the customer using container 220 may request to see a listing of the contents of container 220 by entering a query at a user interface to the data processing system. The user interface may be available at a kiosk, computer, personal digital assistant, or other computing device connected to the data processing system via a network connection. The user interface may also be coupled to a display device, such as at a display device in display devices 214, display devices 216, or display device 226 associated with container 220. The customer may also make such a query after leaving the retail store. For example, a query may be made using a portable device or a home computer workstation.

The listing is then displayed at a location where it may be viewed by the customer, such as on a display device in display devices 214 inside retail facility 202, display devices 216 outside retail facility 202, or display device 226 associated with container 220. The listing may include the quantity of each item in container 220 as well as the price for each, a discount or amount saved off the regular price of each item, and a total price for all items in container 220. Other data may also be displayed as part of the listing, such as, additional incentives to purchase one or more other items available in digital customer marketing environment 200.

When the customer is finished shopping, the customer may proceed to a point-of-sale checkout station. In one embodiment, the checkout station may be coupled to the data processing system. Therefore, the items in container 220 are already known to the data processing system due to the dynamic listing of items in container 220 that is maintained as the customer shops in digital customer marketing environment 200. Thus, no need is present for an employee, customer, or other person to scan each item in container 220 to complete the purchase of each item as is commonly done today. In this example, the customer merely arranges for payment of the total, for example by use of a smart card, credit card, debit card, cash, or other payment method. In some embodiments, it may not be necessary to empty container 220 at the retail facility at all, for example, if container 220 is a minimal cost item which can be kept by the customer.

In other embodiments, container 220 may belong to the customer. In this example, the customer brings container 220 to retail facility 202 at the start of the shopping session. In another embodiment, container 220 belongs to retail facility 202 and must be returned before the customer leaves the parking lot or at some other designated time or place.

In another example, when the customer is finished shopping, the customer may complete checkout either in-aisle or from a final or terminal-based checkout position in the store using a transactional device which may be integral with container 220 or associated temporarily to container 220. The customer may also complete the transaction using a consumer owned computing device, such as a laptop, cellular telephone, or personal digital assistant that is connected to the data processing system via a network connection.

The customer may also make payment by swiping a magnetic strip on a card, using any known or available radio frequency identification (RFID) enabled payment device. The transactional device may also be a portable device such as a laptop computer, palm device, or any other portable device specially configured for such in-aisle checkout service, whether integral with container 220 or separately operable. In this example, the transactional device connects to the data processing system via a network connection to complete the purchase transaction at check out time.

Checkout may be performed in-aisle or at the end of the shopping trip whether from any point or from a specified point of transaction. As noted above, checkout transactional devices may be stationary shared devices or portable or mobile devices offered to the customer from the store or may be devices brought to the store by the customer, which are compatible with the data processing system and software residing on the data processing system.

Thus, in this depicted example, when a customer enters digital customer marketing environment but before the customer enters retail facility 202, such as a retail store, the customer is detected and identified by one or more detectors in detectors 204-210 to generate external data. If the customer takes a shopping container before entering retail facility 202, the shopping container is also identified. In some embodiments, the customer may be identified through identification of the container. Detectors 204-210 may also gather data associated with the customer to form event data.

The customer is tracked using image data and/or other detection data captured by detectors 204-210 as the customer enters retail facility 202. The customer is identified and tracked inside retail facility 202 by one or more detectors inside the facility, such as set of detectors 212. When the customer takes a shopping container, such as container 220, the analysis server uses interl.,gy;nal data from set of detectors 212, such as, identification data from identification tags 230 and 224, to track container 220 and items selected by the customer and placed in container 220.

As a result, an item selected by the customer, for example, as the customer removes the item from its stationary position on a store display, is identified. The selected item may be traced visually by a camera, tracked by another type of detector in set of detectors 212 and/or using identification data from identification tags 230. The item is tracked until the customer places it in container 220.

The analysis server stores a listing of selected items placed in the shopping container. In this example, a single container and a single customer is described. However, the aspects of the illustrative embodiments may also be used to track multiple containers and multiple customers simultaneously. In this case, the analysis server will store a separate listing of selected items for each active customer. As noted above, the listings may be stored in a database. The listing of items in a given container is displayed to a customer, employee, agent, or other customer in response to a query. The listing may be displayed to a customer at any time either while actively shopping, during check-out, or after the customer leaves retail facility 202.

Thus, in one embodiment, a customer entering retail facility 202 is detected by one or more detectors in detectors 204-210. The customer may be identified by the one or more detectors. An analysis server in a data processing system associated with retail facility 202 begins performing data mining on available customer profile information and demographic information for use in generating customized marketing messages targeted to the customer.

The customer may be presented with customized digital marketing messages on one or more display devices in display devices 216 located externally to retail facility 202 before the customer enters retail facility 202.

When the customer enters retail facility 202, the customer is typically offered, provided, or permitted to take shopping container 220 for use during shopping. Container 220 may contain a digital media display, such as display device 226, mounted on container 220 and/or customer may be offered a handheld digital media display device, such as a display device in display devices 214. In the alternative, the customer may be encouraged to use strategically placed kiosks running digital media marketing messages throughout retail facility 202. Display device 226, 214, and/or 216 may include a verification device for verifying an identity of the customer.

For example, display device 214 may include a radio frequency identification tag reader 232 for reading a radio frequency identification tag, a smart card reader for reading a smart card, or a card reader for reading a specialized store loyalty or frequent customer card. Once the customer has been verified, the data processing system retrieves past purchase history, total potential wallet-share, shopper segmentation information, customer profile data, granular demographic data for the customer, and/or any other available customer data elements using known or available data retrieval and/or data mining techniques. The customer data elements are analyzed using a data model to determine appropriate digital media content to be pushed, on-demand, throughout the store to customers viewing display devices 214, 216, and/or display device 226.

This illustrative embodiment provides an intelligent guided selling methodology to optimize customer throughput in the store, thereby maximizing or optimizing total retail content and/or retail sales for the store. The customers are provided with incentives to use display devices 214, 216, and/or display device 226 to obtain promotional offers, rebates, and other discounts. When the customers have finished shopping, the customers may be provided with a list of savings or “tiered” accounting of savings over the regular price of purchased items if a display device had not been used to view and use customized digital marketing messages.

In another example, retail facility 202 includes dispersal device 232. Dispersal device 232 is a device for releasing or dispersing an odor-producing chemical into the air or onto a surface, such as, without limitation, an aerosol spray, a vaporizer, or any other dispersal device. An odor-producing chemical may include any natural or artificial odor-producing chemical. An odor-producing chemical may include, without limitation, an artificial perfume, a natural popcorn smell, a citrus smell, an artificial pheromone, a floral smelling substance produced by flowers and other plants, and/or any other chemical or substance that gives off a scent. In this example, dispersal device 232 may be used to release pleasing or relaxing smells into the air to encourage customers to feel comfortable, improve customers' shopping experience, and/or increase the overall sales by customers.

Next, FIG. 3 is a block diagram of a data processing system in which illustrative embodiments may be implemented. Data processing system 300 is an example of a computer, such as server 104 or client 110 in FIG. 1, in which computer usable code or instructions implementing the processes may be located for the illustrative embodiments.

In the depicted example, data processing system 300 employs a hub architecture including a north bridge and memory controller hub (MCH) 302 and a south bridge and input/output (I/O) controller hub (ICH) 304. Processing unit 306, main memory 308, and graphics processor 310 are coupled to north bridge and memory controller hub 302. Processing unit 306 may contain one or more processors and even may be implemented using one or more heterogeneous processor systems. Graphics processor 310 may be coupled to the MCH through an accelerated graphics port (AGP), for example.

In the depicted example, local area network (LAN) adapter 312 is coupled to south bridge and I/O controller hub 304 and audio adapter 316, keyboard and mouse adapter 320, modem 322, read only memory (ROM) 324, universal serial bus (USB) ports and other communications ports 332, and PCI/PCIe devices 334 are coupled to south bridge and I/O controller hub 304 through bus 338, and hard disk drive (HDD) 326 and CD-ROM drive 330 are coupled to south bridge and I/O controller hub 304 through bus 340. PCI/PCIe devices may include, for example, Ethernet adapters, add-in cards, and PC cards for notebook computers. PCI uses a card bus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. A super I/O (SIO) device 336 may be coupled to south bridge and I/O controller hub 304.

An operating system runs on processing unit 306 and coordinates and provides control of various components within data processing system 300 in FIG. 3. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 300. Java and all Java-based trademarks are trademarks of Sun Microsystems, Inc. in the United States, other countries, or both.

Instructions for the operating system, the object-oriented programming system, and applications or programs are located on storage devices, such as hard disk drive 326, and may be loaded into main memory 308 for execution by processing unit 306. The processes of the illustrative embodiments may be performed by processing unit 306 using computer implemented instructions, which may be located in a memory such as, for example, main memory 308, read only memory 324, or in one or more peripheral devices.

In some illustrative examples, data processing system 300 may be a personal digital assistant (PDA), which is generally configured with flash memory to provide non-volatile memory for storing operating system files and/or customer-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 308 or a cache such as found in north bridge and memory controller hub 302. A processing unit may include one or more processors or CPUs.

The depicted examples in FIGS. 1-3 are not meant to imply architectural limitations. The hardware in FIGS. 1-3 may vary depending on the implementation. Other internal hardware or peripheral devices, such as flash memory, equivalent non-volatile memory, or optical disk drives and the like, may be used in addition to or in place of the hardware depicted in FIGS. 1-3. Also, the processes of the illustrative embodiments may be applied to a multiprocessor data processing system.

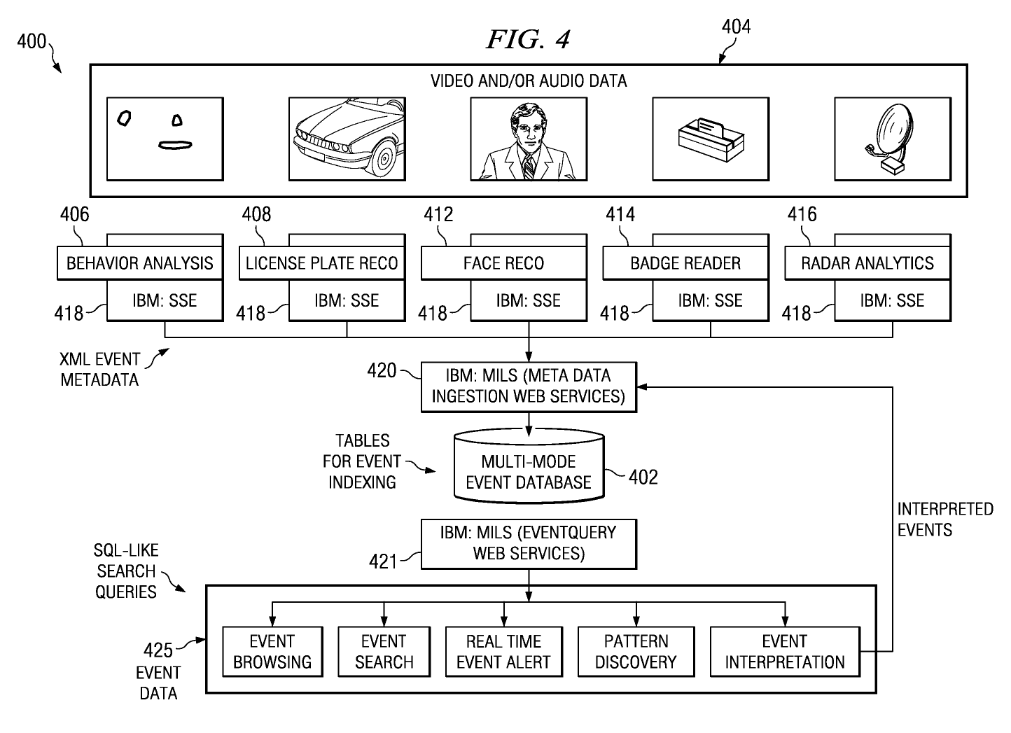

With reference now to FIG. 4, a diagram of a smart detection system is depicted in accordance with an illustrative embodiment of the present invention. Smart detection is the use of computer vision and pattern recognition technologies to analyze detection data gathered from situated cameras and microphones. The analysis of the detection data generates events of interest in the environment. For example, an event of interest at a departure drop off area in an airport includes “cars that stop in the loading zone for extended periods of time”. As smart detection technologies have matured, they have typically been deployed as isolated applications which provide a particular set of functionalities.

Smart detection system 400 is a smart detection system architecture for analyzing video images captured by a camera and/or audio captured by an audio detection device. Smart detection system 400 includes software for analyzing video and/or audio data 404. In this example, smart detection system 400 processes video and/or audio data 404 for the customer and/or the customer's vehicle into data and metadata to form event data 425. Smart detection system 400 may be implemented using any known or available software for performing voice analysis, facial recognition, license plate recognition, and sound analysis. In this example, smart detection system 400 is implemented as IBM® smart surveillance system (S3) software.

An audio/video capture device is any type of known or available device for capturing video images and/or capturing audio. The audio/video capture device may be, but is not limited to, a digital video camera, a microphone, a web camera, or any other device for capturing sound and/or video images. For example, the audio/video capture device may be implemented as detectors 204-210 and/or set of detectors 212 in FIG. 2.

Video and/or audio data 404 is detection data captured by the audio/video capture devices. Video and/or audio data 404 may be a sound file, a media file, a moving video file, a media file, a still picture, a set of still pictures, or any other form of image data and/or audio data. Video and/or audio data 404 may also be referred to as detection data. Video and/or audio data 404 may include images of a customer's face, an image of a part or portion of a customer's car, an image of a license plate on a customer's car, and/or one or more images showing a customer's behavior. An image showing a customer's behavior or appearance may show a customer wearing a long coat on a hot day, a customer walking with two small children which may be the customer's children or grandchildren, a customer moving in a hurried or leisurely manner, or any other type of behavior or appearance attributes of a customer, the customer's companions, or the customer's vehicle.

In this example, smart detection system 400 architecture is adapted to satisfy two principles. 1) Openness: The system permits integration of both analysis and retrieval software made by third parties. In one embodiment, the system is designed using approved standards and commercial off-the-shelf (COTS) components. 2) Extensibility: The system should have internal structures and interfaces that will permit for the functionality of the system to be extended over a period of time.

The architecture enables the use of multiple independently developed event analysis technologies in a common framework. The events from all these technologies are cross indexed into a common repository or a multi-mode event database 402 allowing for correlation across multiple audio/video capture devices and event types.

Smart detection system 400 includes the following illustrative technologies integrated into a single system. License plate recognition technology 408 may be deployed at the entrance to a facility where license plate recognition technology 408 catalogs a license plate of each of the arriving and departing vehicles in a parking lot associated with the retail facility.

Behavior analysis technology 406 detects and tracks moving objects and classifies the objects into a number of predefined categories. As used herein, an object may be a human customer, an item, a container, a shopping cart or shopping basket, or any other object inside or outside the retail facility. Behavior analysis technology 406 could be deployed on various cameras overlooking a parking lot, a perimeter, or inside a facility.

Face detection/recognition technology 412 may be deployed at entry ways to capture and recognize faces. Badge reader technology 414 may be employed to read badges. Radar analytics technology 416 may be employed to determine the presence of objects. Events from access control technologies can also be integrated into smart detection system 400. The data gathered from behavior analysis technology 406, license plate recognition technology 408, face detection/recognition technology 412, badge reader technology 414, radar analytics technology 416, and any other video/audio data received from a camera or other video/audio capture device is received by smart detection system 400 for processing into event data 425.

The events from all the above surveillance technologies are cross indexed into a single repository, such as multi-mode database 402. In such a repository, a simple time range query across the modalities will extract license plate information, vehicle appearance information, badge information, and face appearance information, thus permitting an analyst to easily correlate these attributes. The architecture of smart detection system 400 also includes one or more smart surveillance engines (SSEs) 418, which house event detection technologies.

Smart detection system 400 further includes Middleware for Large Scale Surveillance (MILS) 420 and 421, which provides infrastructure for indexing, retrieving, and managing event metadata.

In this example, video and/or audio data 404 is received from a variety of audio/video capture devices, such as detectors 204-210 in FIG. 2. Video and/or audio data 404 is processed in SSEs 418. Each SSE 418 can generate real-time alerts and generic event metadata. The metadata generated by SSE 418 may be represented using extensible markup language (XML). The XML documents include a set of fields which are common to all engines and others which are specific to the particular type of analysis being performed by SSE 418. In this example, the metadata generated by SSEs 418 is transferred to a backend MILS system 420. This may be accomplished via the use of, for example, web services data ingest application program interfaces (APIs) provided by MILS 420. The XML metadata is received by MILS 420 and indexed into predefined tables in multi-mode event database 402. This may be accomplished using, for example, and without limitation, the DB2™ XML extender, if an IBM® DB2™ database is employed. This permits for fast searching using primary keys. MILS 421 provides a number of query and retrieval services based on the types of metadata available in the database. Retrieval services 425 may include, for example, event browsing, event search, real time event alert, or pattern discovery event interpretation. Each event has a reference to the original media resource, such as, without limitation, a link to the video file. This allows the user to view the video associated with a retrieved event.

Smart detection system 400 provides an open and extensible architecture for smart video surveillance. SSEs 418 preferably provide a plug and play framework for video analytics. The event metadata generated by SSEs 418 may be sent to multi-mode event database 402 as XML files. Web services API's in MILS 420 permit for easy integration and extensibility of the metadata. Various applications, such as, without limitation, event browsing, real time alerts, etc. may use structure query language (SQL) or similar query language through web services interfaces to access the event metadata from multi-mode event database 402.

The smart surveillance engine (SSE) 418 may be implemented as a C++ based framework for performing real-time event analysis. SSE 418 is capable of supporting a variety of video/image analysis technologies and other types of sensor analysis technologies. SSE 418 provides at least the following support functionalities for the core analysis components. The support functionalities are provided to programmers or users through a plurality of interfaces employed by SSE 418. These interfaces are illustratively described below.

In one example, standard plug-in interfaces may be provided. Any event analysis component which complies with the interfaces defined by SSE 418 can be plugged into SSE 418. The definitions include standard ways of passing data into the analysis components and standard ways of getting the results from the analysis components. Extensible metadata interfaces are provided. SSE 418 provides metadata extensibility. For example, consider a behavior analysis application which uses detection and tracking technology. Assume that the default metadata generated by this component is object trajectory and size. If the designer now wishes to add color of the object into the metadata, SSE 418 enables this by providing a way to extend the creation of the appropriate XML structures for transmission to the backend (MILS) system 420.

SSE 418 provides standard ways of accessing event metadata in memory and standardized ways of generating and transmitting alerts to the backend (MILS) system 420. In many applications, users will need the use of multiple basic real-time alerts in a spatio-temporal sequence to compose an event that is relevant in the user's application context. SSE 418 provides a simple mechanism for composing compound alerts via compound alert interfaces. In many applications, the real-time event metadata and alerts are used to actuate alarms, visualize positions of objects on an integrated display, and control cameras to get better surveillance data. SSE 418 provides developers with an easy way to plug-in actuation modules which can be driven from both the basic event metadata and by user-defined alerts using real-time actuation interfaces.

Using database communication interfaces, SSE 418 also hides the complexity of transmitting information from the analysis engines to multi-mode event database 402 by providing simple calls to initiate the transfer of information.

The IBM Middleware for Large Scale Surveillance (MILS) 420 and 421 may include a J2EE™ frame work built around IBM's DB2™ and IBM WebSphere™ application server platforms. MILS 420 supports the indexing and retrieval of spatio-temporal event meta. MILS 420 also provides analysis engines with the following support functionalities via standard web services interfaces using XML documents.

MILS 420 and 421 provide metadata ingestion services. These are web services calls which allow an engine to ingest events into MILS 420 and 421 system. There are two categories of ingestion services. 1) Index Ingestion Services This permits for the ingestion of metadata that is searchable through SQL like queries. The metadata ingested through this service is indexed into tables which permit content based searches such as provided by MILS 420. 2) Event Ingestion Services: This permits for the ingestion of events detected in SSE 418, such as provided by MILS 421. For example, a loitering alert that is detected can be transmitted to the backend along with several parameters of the alert. These events can also be retrieved by the user but only by the limited set of attributes provided by the event parameters.

MILS 420 and/or 421 provide schema management services. Schema management services are web services which permit a developer to manage their own metadata schema. A developer can create a new schema or extend the base MILS schema to accommodate the metadata produced by their analytical engine. In addition, system management services are provided by MILS 420 and/or 421.

The schema management services of MILS 420 and 421 provide the ability to add a new type of analytics to enhance situation awareness through cross correlation. For example, a marketing model for a monitored retail marketing environment is dynamic and can change over time. For example, marketing strategies to sell soft drinks may be very different in December than in mid-summer. Thus, it is important to permit smart detection system 400 to add new types of analytics and cross correlate the existing analytics with the new analytics. To add/register a new type sensor and/or analytics to increase situation awareness, a developer can develop new analytics and plug them into SSE 418 and employ MILS's schema management service to register new intelligent tags generated by the new SSE analytics. After the registration process, the data generated by the new analytics can become immediately available for cross correlating with existing index data.

System management services provide a number of facilities needed to manage smart detection system 400 including: 1) Camera Management Services: These services include the functions of adding or deleting a camera from a MILS system, adding or deleting a map from a MILS system, associating a camera with a specific location on a map, adding or deleting views associated with a camera, assigning a camera to a specific MILS server and a variety of other functionality needed to manage the system. 2) Engine Management Services: These services include functions for starting and stopping an engine associated with a camera, configuring an engine associated with a camera, setting alerts on an engine and other associated functionality. 3) User Management Services: These services include adding and deleting users to a system, associating selected cameras to a viewer, associating selected search and event viewing capacities to a user and associating video viewing privilege to a user. 4) Content Based Search Services: These services permit a user to search through an event archive using a plurality of types of queries.

For the content based search services (4), the types of queries may include: A) Search by Time retrieves all events from event data 425 that occurred during a specified time interval. B) Search by Object Presence retrieves the last 100 events from a live system. C) Search by Object Size retrieves events where the maximum object size matches the specified range. D) Search by Object Type retrieves all objects of a specified type. E) Search by Object Speed retrieves all objects moving within a specified velocity range. F) Search by Object Color retrieves all objects within a specified color range. G) Search by Object Location retrieves all objects within a specified bounding box in a camera view. H) Search by Activity Duration retrieves all events from event data 425 with durations within the specified range. I) Composite Search combines one or more of the above capabilities. Other system management services may also be employed.

Referring now to FIG. 5, a block diagram of a data processing system for analyzing event data to identify event patterns for generating a marketing model is shown in accordance with an illustrative embodiment. Data associated with a group of customers includes event data and any available internal data and/or external data associated with the group of customers. Data processing system 500 is a data processing system, such as data processing system 100 in FIG. 1 and/or data processing system 300 in FIG. 3.

Analysis server 502 is any type of known or available server for analyzing dynamic customer data elements for use in generating customized digital marketing messages. Analysis server 502 may be a server, such as server 104 in FIG. 1 or data processing system 300 in FIG. 3. Analysis server 502 includes set of data models 504 for analyzing dynamic customer data elements and static customer data elements.

Static customer data elements are data elements that do not tend to change in real time. Examples of static data elements include a customer's name and address. Dynamic customer data elements are data elements that are changing in real-time. For example, dynamic customer data elements could include, without limitation, the current contents of a customer's shopping basket, the time of day, the day of the week, whether it is the customer's birthday or other holiday observed by the customer, customer's responses to marketing messages and/or items viewed by the customer, customer location, and/or any other dynamic customer information. Event data is a dynamic customer data element.

Set of data models 504 is one or more data models created a priori or pre-generated for use in analyzing event data 516 to identify event patterns and generate optimized marketing model 505. Set of data models 504 includes one or more data models for parsing event data, identifying events of interest, and determining patterns or relationships between the events of interest. Set of data models 504 are generated using statistical, data mining, and simulation or modeling techniques. In this example, set of data models 504 includes, but is not limited to, a unifying data model, system data models, event data models, and/or user data models. These data models are discussed in greater detail in FIG. 6 below.

Optimized marketing model 505 is a model, set of definitions, suggestions, and/or parameters for implementing an optimized marketing strategy in a retail environment. Optimized marketing model 505 may include, without limitation, suggestions for placement of display device 532 and/or placement of items in the retail marketing environment. Optimized marketing model 505 may also include instructions for a type or style of music to be played in a certain area of the retail environment, an optimal temperature that should be maintained, scents, perfumes, or artificial pheromones that should be released into the air at a particular location, and an optimal color that should be used in signage, decorations, or paint. In addition, optimized marketing model 505 may suggest or provide optimal placement of shelves, displays, or racks, as well as any other information regarding placement of one or more items in the retail environment based on patterns of events identified in event data 516.

Profile data 506 is data regarding one or more customers. Profile data 506 includes point of contact data, profiled past data, current actions data, transactional history data, transactional history data, certain click-stream data, granular demographics 508, psychographic data 510, registration data, and account data and/or any other data regarding a customer. Registration data may include customer provided data regarding the customer, such as name, address, telephone number, email address, fax number, place of employment, or any other customer information.

Point of contact data is data regarding a method or device used by a customer to interact with a data processing system of a merchant or supplier and/or receive customized marketing message 530 for display. The customer may interact with the merchant or supplier using a computing device or display terminal having a user interface for inputting data and/or receiving output. The device or terminal may be a device provided by the retail facility and/or a device belonging to or provided by the customer. For example, the display or access device may include, but is not limited to, a cellular telephone, a laptop computer, a desktop computer, a computer terminal kiosk, personal digital assistant (PDA), or any other display or access device, such as display device 532.

If display device 532 is a display device associated with the retail facility, details and information regarding display device 532 will be known to analysis server 502. However, if display device 532 is a display device belonging to the customer or brought to the retail facility by the customer, analysis server 502 may identify the type of display device using techniques such as interrogation commands, cookies, or any other known or equivalent technique. From the type of device, other constraints may be determined, such as display size, resolution, refresh rate, color capability, keyboard entry capability, other entry capability such as pointer or mouse, speech recognition and response, language constraints, and any other fingertip touch point constraints and assumptions about customer state of the display device. For example, someone using a cellular phone has a limited time window and is sensitive to location and local time of day, whereas a casual home browser may have a greater luxury of time and faster connectivity.

An indication of a location for the point of contact may also be determined. For example, global positioning system (GPS) coordinates of the customer may be determined if the customer device has such a capability whether by including a real time global positioning system receiver or by periodically storing global positioning system coordinates entered by some other method. Other location indications may also be determined such as post office address, street or crossroad coordinates, latitude-longitude coordinates or any other location indicating system.

Analysis server 502 may also determine the connectivity. For example the customer may be connected to the merchant or supplier in any of a number ways such as a modem, digital modem, network, wireless network, Ethernet, intranet, or high speed lines including fiber optic lines. Each way of connection imposes constraints of speed, latency, and/or mobility which can then also be determined.

The profiled past comprises data for individualization of customized marketing message 530. Global profile data may be retrieved from a file, database, data warehouse or any other data storage device. Multiple storage devices and software may also be used. Some or all of the data may be retrieved from the point of contact device, as well. The profiled past may comprise an imposed profile, global profile, individual profile, and demographic profile. The profiles may be combined or layered to define the customer for specific promotions and marketing offers.

In the illustrative embodiments, a global profile includes data on the customer's interests, preferences, and affiliation. The profiled past may also comprise retrieving purchased data. Various firms provide data for purchase which is grouped or keyed to presenting a lifestyle or life stage view of customers by block or group or some other baseline parameter. The purchased data presents a view of the customer based on aggregation of data points such as, but not limited to geographic block, age of head of household, income level, number of children, education level, ethnicity, and buying patterns.

The profiled past may also include navigational data relating to the path the customer used to arrive at a web page which indicates where the customer came from or the path the customer followed to link to the merchant or supplier's web page. Transactional data of actions taken is data regarding a transaction. For example, transaction data may include data regarding whether the transaction is a first time transaction or a repeat transaction, and/or how much the customer usually spends. Information on how much a customer generally spends during a given transaction may be referred to as basket share. Data voluntarily submitted by the customer in responding to questions or a survey may also be included in the profiled past.

Current actions, also called a current and historical record, are also included in profile data 506. Current actions are data defining customer behavior. One source of current actions is listings of the purchases made by the customer, payments and returns made by the customer, and/or click-stream data from a point of contact device of the customer. Click-stream data is data regarding a customer's navigation of an online web page of the merchant or supplier. Click-stream data may include page hits, sequence of hits, duration of page views, response to advertisements, transactions made, and conversion rates. Conversion rate is the number of times the customer takes action divided by the number of times an opportunity is presented.

In this example, profiled past data for a group of customers is stored in analysis server 502. However, in accordance with the illustrative embodiments, profiled past data may also be stored in any local or remote data storage device, including, but not limited to, a device such as storage area network 108 in FIG. 1 or read only memory (ROM) 324 and/or compact disk read only memory (CD-ROM) 330 in FIG. 3.

Granular demographics 508 include data associated with a detailed demographics profile for one or more customers. Granular demographics 508 may include, without limitation, ethnicity, block group, lifestyle, life stage, income, and education data. Granular demographics 508 may be used as an additional layer of profile data 506 associated with a customer.

Psychographic data 510 refers to an attitude profile of the customer. Examples of attitude profiles include a trend buyer or a time-strapped person who prefers to purchase a complete outfit, or a professional buyer who prefers to mix and match individual items from various suppliers.

Internal data 512 is data associated with a group of customers that is pre-generated and/or data that is gathered inside a retail facility. For example, internal data may include data received from a set of detectors located internally or inside of a retail facility, such as set of detectors 212 in FIG. 2. For example, internal data 512 includes, but is not limited to, profile data 506, granular demographics 508, psychographic data 510, point of contact data, transactional history data, current actions data, items currently in the customer's shopping cart, and/or profiled past data.

External data 514 is data gathered by one or more detection devices located externally to a retail facility, such as retail facility 202 in FIG. 2. The one or more detection devices may be any type of detection devices for detecting a presence of a customer, animal, or object outside of the retail facility. External data 514 may include data regarding detection of a presence of a group of customers outside a retail facility, a detection of the group of customers outside the retail facility that is moving toward an entrance to the retail facility indicating that one or more customers in the group of customers are about to go inside the facility, and/or detection of one or more customers exiting the retail facility. External data 514 may also indicate detection of a presence of a customer's vehicle, such as a car, bicycle, motorcycle, bus, or truck. For example, the detection devices may be detectors such as detectors 204-210 in FIG. 2.

Event data 516 is data or metadata describing events occurring in the retail marketing environment. Event data 516 is processed to form dynamic data. Dynamic data includes patterns of events. In one embodiment, the dynamic data includes patterns of events that are of interest to marketing efforts. Dynamic data may also include internal data 512 and/or external data 514, such as motion detector information, for one or more customers.

Processing event data 516 may include processing any available internal data 512 and/or external data 514 with event data 516. Processing event data 516 may include, but is not limited to, filtering event data 516 for relevant data elements, combining event data 516 with internal data 512 and/or external data 514, comparing event data 516 to baseline or comparison models for external data, and/or formatting event data 516 for utilization and/or analysis in one or more data models in set of data models 504 to form the dynamic data.

The processed event data 516 and any available internal data 512 and/or external data 514 forms dynamic data (not shown). The dynamic data, which includes patterns of events of interest, is analyzed and/or further processed using one or more data models in set of data models 504 to generate optimized marketing model 505. Dynamic data may also be used to generate marketing message criteria which are used to generate customized marketing message 530.

Content server 522 is any type of known or available server for storing modular marketing messages 524. Content server 522 may be a server, such as server 104 in FIG. 1 or data processing system 300 in FIG. 3.

Modular marketing messages 524 are two or more self contained marketing messages that may be combined with one or more other modular marketing messages in modular marketing messages 524 to form a customized marketing message for display to a customer or a particular group of customers. Modular marketing messages 524 can be quickly and dynamically assembled and disseminated to the customer in real-time. Two or more modular marketing messages are combined to dynamically generate customized marketing message 530. Customized marketing message 530 is a message that is customized or personalized for a particular customer.

Derived marketing messages 526 is a software component for determining which modular marketing messages in modular marketing messages 524 should be combined or utilized to dynamically generate customized marketing message 530 for the customer in real time. Derived marketing messages 526 uses the output generated by analysis server 502, such as marketing message criteria, to identify one or more modular marketing messages for the customer. The output generated by analysis server 502 from analyzing event data 516 and any available internal data 512 and/or external data 514 using appropriate data models in set of data models 504 includes marketing message criteria for the customer.

Derived marketing messages 526 uses the marketing message criteria for a particular customer to select one or more modular marketing messages in modular marketing messages 524. Dynamic marketing message assembly 528 is a software component for combining the one or more modular marketing messages selected by derived marketing messages 526 to form customized marketing message 530.

Customized marketing message 530 is a customized and unique marketing message. The marketing message is a one-to-one customized marketing message for a specific customer. Customized marketing message 530 is generated using event data 516, any available external data 514, and/or internal data 512, such as the customer's demographics and psychographics, to achieve this unique one-to-one marketing.

Customized marketing message 530 is generated for a particular customer based on dynamic customer data elements, such as event data in event data 516 that is related to a particular customer. For example, if event data for a particular customer indicates that the customer is sneezing and sniffling a lot, modular marketing messages 524 include marketing messages related to cold and flu medications, tissues, and/or sleeping aids. Customized marketing message 530 may be generated using the selected marketing messages. Customized marketing message 530 is generated especially for display to the customer with the cold/flu symptoms, rather than displaying the exact same marketing messages to all customers. Customized marketing message 530 is displayed on display device 532.

Customized marketing message 530 may include advertisements, sales, special offers, incentives, opportunities, promotional offers, rebate information and/or rebate offers, discounts, and opportunities. An opportunity may be a “take action” opportunity, such as asking the customer to make an immediate purchase, select a particular item, request a download, provide information, or take any other type of action.

Customized marketing message 530 may also include content or messages pushing advertisements and opportunities to effectively and appropriately drive the point of contact customer to some conclusion or reaction desired by the merchant.

Customized marketing message 530 is formed in a dynamic closed loop manner in which the content delivery depends on event data 516, external data 514, and/or internal data 512, such as profile data 506 and granular demographics 508. Therefore, all interchanges with the customer may sense and gather data associated with customer behavior, which is used to generate customized marketing message 530.

Display device 532 is a multimedia display for presenting customized marketing messages to one or more customers. Display device 532 may be a multimedia display, such as, but not limited to, display devices 214, 216, and 226 in FIG. 2. Display device 532 may be, for example, a personal digital assistant (PDA), a cellular telephone with a display screen, an electronic sign, a laptop computer, a tablet PC, a kiosk, a digital media display, a display screen mounted on a shopping container, and/or any other type of device for displaying digital messages to a customer.

Thus, a merchant has a capability for interacting with the customer on a direct one-to-one level by sending customized marketing message 530 to display device 532. Customized marketing message 530 may be sent and displayed to the customer via a network. For example, customized marketing message 530 may be sent via a web site accessed as a unique uniform resource location (URL) address on the World Wide Web, as well as any other networked connectivity or conventional interaction including, but not limited to, a telephone, computer terminal, cell phone or print media.

In another embodiment, display device 532 includes a printer for printing customized marketing message 530. For example, display device 532 may be a display device mounted on a shopping cart, a shopping basket, a shelf or compartment in a retail facility, included in a handheld device carried by the customer, or mounted on a wall in the retail facility. In response to displaying customized marketing message 530, a customer can select to print the customized marketing message 530 as a coupon and/or as a paper or hard copy for later use. In another embodiment, display device 532 automatically prints customized marketing message 530 for the customer rather than displaying customized marketing message 530 on a display screen or in addition to displaying customized marketing message 530 on the display screen.

In another embodiment, display device 532 provides an option for a customer to save customized marketing message 530 in an electronic form for later use. For example, the customer may save customized marketing message 530 on a hand held display device, on a flash memory, a customer account in a data base associated with analysis server 502, or any other data storage device. In this example, when customized marketing message 530 is displayed to the customer, the customer is presented with a “use offer now” option and a “save offer for later use” option. If the customer chooses the “save offer” option, the customer may save an electronic copy of customized marketing message 530 and/or print a paper copy of customized marketing message 530 for later use.

In this example, customized marketing message 530 is generated and delivered to the customer in response to an analysis of event data 516, internal data 512, and external data 514.

FIG. 6 is a block diagram of a unifying data model for processing event data in accordance with an illustrative embodiment. The event data generated by a smart detection system may be processed by one or more data models in a set of data models, such as set of data models 504 in FIG. 5, to identify patterns in the events. Unifying data model 600 is an example of a data model for processing event data.

In this example, unifying data model 600 has three types of data models, namely, 1) system data models 602 which captures the specification of a given monitoring system, including details like geographic location of the system, number of cameras, physical layout of the monitored space, and other details regarding the retail marketing environment; 2) user data models 604 models users, privileges and user functionality; and 3) event data models 606 which captures the events that occur in a specific sensor or zone in the monitored space. Each of these data models is described below.

System data models 602 has a number of components. These may include sensor/camera data models 608. The most fundamental component of sensor/camera data models 608 is a view. A view is defined as some particular placement and configuration, such as a location, orientation, and/or parameters, of a sensor. In the case of a camera, a view would include the values of the pan, tilt and zoom parameters, any lens and camera settings and position of the camera. A fixed camera can have multiple views. The view “Id” may be used as a primary key to distinguish between events being generated by different sensors. A single sensor can have multiple views. Sensors in the same geographical vicinity are grouped into clusters, which are further grouped under a root cluster. There is one root cluster per MILS server.

Engine data models 610 provide a comprehensive security solution which utilizes a wide range of event detection technologies. Engine data models 610 captures at least some of the following information about the analytical engines: Engine Identifier: A unique identifier assigned to each engine; Engine Type: This denotes the type of analytic being performed by the engine, for example face detection, behavior analysis, and/or LPR; and Engine Configuration: This captures the configuration parameters for a particular engine.

User data models 604 captures the privileges of a given user. These may include selective access to camera views; selective access to camera/engine configuration and system management functionality; and selective access to search and query functions.

Event data models 606 represent the events that occur within a space that may be monitored by one or more cameras or other sensors. A time line data model may also be employed as discussed above. Time line data models 607 uses time as a primary synchronization mechanism for events that occur in the real world, which is monitored through sensors. The basic MILS schema allows multiple layers of annotations for a given time span.

FIG. 7 is a flowchart illustrating a smart detection system generating event data in accordance with an illustrative embodiment. The process in FIG. 7 may be implemented by a smart detection system, such as smart detection system 400 in FIG. 4.

The process begins by receiving detection data from a set of cameras (step 702). The process analyzes the detection data using multiple analytical technologies to detect events (step 704). The multiple technologies may include, for example, a behavior analysis engine, a license plate recognition engine, a face recognition engine, a badge reader engine, and/or a radar analytic engine.

Events are cross correlated in a unifying data model to identify patterns of events (step 706). Cross correlating provides integrated situation awareness across the multiple analytical technologies. The cross correlating may include correlating events to a time line to associate events to define an integrated event. The patterns of events are indexed and stored in a repository, such as a database (step 708) with the process terminating thereafter.

In the example in FIG. 7, the database can be queried to determine whether an integrated event matches the query. This includes employing cross correlated information from a plurality of information technologies and/or sources. New analytical technologies also may be registered. The new analytical technologies can employ model and cross correlate with existing analytical technologies to provide a dynamically configurable surveillance system.

In this example, detection data is received from a set of cameras. However, in other embodiments, detection data may come from other detection devices, such as, without limitation, a badge reader, a microphone, a motion detector, a heat sensor, or a radar.

FIG. 8 is a flowchart illustrating a process for generating an optimized marketing model in accordance with an illustrative embodiment. The process in FIG. 8 may be implemented by an analysis server, such as analysis server 502 in FIG. 5.

The process begins by retrieving event data (step 802). Event data may be retrieved from a data storage device, such as a relational database, a multimodal database, or any other data storage. The event data includes metadata describing events occurring inside a retail facility or outside a retail facility. Event data may include data describing customers' appearance, customers' actions, customers' vehicles, a customer's companions, the movements and/or speed or pace of one or more customers shopping or otherwise moving through the retail facility.

The process parses the event data to identify patterns in the events (step 804). Parsing the event data may include, but is not limited to, processing the event data using a statistical method, a data mining method, a causal model, a mathematical model, a marketing model, a behavioral model, a psychological model, a sociological model, and/or a simulation model.

Next, the process identifies events in the patterns of events that achieve a target outcome to form optimized events (step 806). A target outcome refers to outcomes that improve sales of items, customer satisfaction, a customer's shopping experience, or otherwise improves market basket revenues.

The process uses the optimized events to generate an optimized marketing model (step 808) with the process terminating thereafter. In this example, the optimized marketing model includes a marketing strategy that provides suggestions regarding placement of items, also referred to as product placement, placement of display devices displaying customized marketing messages, sounds and music played over a sound system, the volume of sounds and music played over the sound system, natural and artificial scents and pheromones to be released into the air at particular locations, placement of product samples for customers to try, the colors of decorations and signs, and/or any other strategies to improve or optimize marketing efforts.

The illustrative embodiments provide a computer implemented method, apparatus, and computer usable program code for generating an optimized marketing model for marketing items to customers in a retail facility. In one embodiment, event data is parsed to identify patterns of events, wherein the event data comprises metadata describing events associated with the retail facility; events in the patterns of events that achieve a target outcome are identified to form optimized events. A marketing strategy is generated using the optimized events to form the optimized marketing model.

The illustrative embodiments permit merchants to utilize information regarding the behavior, event patterns, and actions of groups of customers to develop and improve marketing strategies using audio and/or video data associated with groups of customers. In addition, the illustrative embodiments allow audio and/or video data to be automatically analyzed using the smart detection system without requiring a human user to manually review or monitor the video images and/or audio recordings. In this manner, a merchant can save both time and money that would otherwise be expended to manually identify customers' behavior, actions, and other patterns of events in a particular retail facility. Moreover, marketing strategies are automatically and dynamically updated to take into account changing trends in customer behavior. For example and without limitation, as the weather becomes warmer and customers change their parking habits to take advantage of shaded or covered parking, the analysis server of the illustrative embodiments recognizes these changes in event patterns and modifies marketing strategies to take into account the change in customers' parking locations.

The illustrative embodiments provide a safe, productive, and risk-free retail environment where good customers can continue to experience maximum price benefits. The illustrative embodiments allow merchants to encourage impulse shopping and manage market basket revenue. The preferences or likes and dislikes of a customer may better be determined and exploited to increase sales of items to the targeted customer. This may enable maximizing or optimizing sales of retail items sold to a customer at each visit the customer makes to the retail facility, which translates into maximizing or optimizing the potential wallet share attributable to the customer.

In addition, because marketing incentives are presented to a customer on a digital display device, shelving space is no longer at a premium. The location of an item on the shelf, such as at eye level as opposed to being placed at floor level, will be less important in view of the marketing incentives being pushed to the customer as the customer shops.

The embodiments also permit increased monitoring of purchased and/or offered items per customer segment and more effective marketing campaigns. Thus, a retail outlet may conservatively increase sales/profits by ten to twenty percent on a year to year basis.

The flowcharts and block diagrams in the different depicted embodiments illustrate the architecture, functionality, and operation of some possible implementations of apparatus, methods and computer program products. In this regard, each step in the flowcharts or block diagrams may represent a module, segment, or portion of code, which comprises one or more executable instructions for implementing the specified function or functions. In some alternative implementations, the function or functions noted in the step may occur out of the order noted in the figures. For example, in some cases, two steps shown in succession may be executed substantially concurrently, or the blocks may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for generating an optimized marketing model for marketing items in a retail facility, the computer implemented method comprising:
parsing event data to identify patterns of events, wherein the event data comprises metadata describing events associated with the retail facility;
identifying the events in the patterns of events that achieve a target outcome to form optimized events; and
generating a marketing strategy using the optimized events to form the optimized marketing model.

2. The computer implemented method of claim 1 wherein the target outcome is associated with increasing sales of a set of items.

3. The computer implemented method of claim 1 wherein the target outcome is associated with increasing an amount of time a customer shops in the retail facility.

4. The computer implemented method of claim 1 wherein the optimized marketing model comprises a set of locations for a set of display devices associated with the retail facility, wherein the set of display devices display customized marketing messages to customers.

5. The computer implemented method of claim 1 wherein the optimized marketing model comprises a set of locations for placement of a set of items associated with the retail facility, wherein the set of locations are locations for the set of items that will increase a likelihood that a customer will purchase an item in the set of items.

6. The computer implemented method of claim 1 further comprising:
receiving video data from a set of cameras associated with the retail facility; and
analyzing the video data to form the event data, wherein analyzing the video data comprises generating the metadata describing the events associated with the retail facility.

7. The computer implemented method of claim 6 wherein analyzing the video data further comprising:
receiving detection data from a set of detectors located inside the retail facility;
analyzing the detection data to form internal data; and
processing the internal data with the video data to form the event data.

8. The computer implemented method of claim 6 wherein analyzing the video data further comprising:
receiving detection data from a set of detectors located outside the retail facility;
analyzing the detection data to form external data; and
processing the external data with the video data to form the event data.

9. The computer implemented method of claim 6 wherein analyzing the video data further comprising:
analyzing the video data with detection data gathered by a set of detectors associated with the retail facility, wherein the set of detectors includes at least one of a microphone, a pressure sensor, a device for detecting odors, a motion detector, and a thermal sensor.

10. The computer implemented method of claim 1, wherein parsing the event data further comprises:
processing the event data using at least one of a statistical method, a data mining method, a causal model, a mathematical model, a marketing model, a behavioral model, a psychological model, a sociological model, or a simulation model.

11. A computer program product comprising:
computer usable program code for generating an optimized marketing model for marketing items in a retail facility, the computer program product comprising:
computer usable program code for parsing event data using data mining techniques to identify patterns of events, wherein the event data comprises metadata describing events associated with the retail facility;
computer usable program code for identifying the events in the patterns of events that achieve a target outcome to form optimized events; and
computer usable program code for generating a marketing strategy using the optimized events to form the optimized marketing model.

12. The computer program product of claim 11 wherein the target outcome is associated with increasing sales of a set of items.

13. The computer program product of claim 11 wherein the target outcome is associated with increasing an amount of time a customer shops in the retail facility.

14. The computer program product of claim 11 wherein the optimized marketing model comprises a set of locations for a set of display devices associated with the retail facility, and wherein the set of display devices display customized marketing messages to customers.

15. The computer program product of claim 11 wherein the optimized marketing model comprises a set of locations for placement of a set of items associated with the retail facility, wherein the set of locations are locations for the set of items that will increase a likelihood that a customer will purchase an item in the set of items.

16. A system for generating an optimized marketing model for marketing items in a retail facility, the system comprising:
a database, wherein the database stores event data associated with the retail facility;
an analysis server, wherein the analysis server parses the event data using data mining techniques to identify patterns of events, wherein the event data comprises metadata describing events associated with the retail facility; identifies the events in the patterns of events that achieve a target outcome to form optimized events; and generates a marketing strategy using the optimized events to form the optimized marketing model.

17. The system of claim 16 further comprising:
a set of digital video cameras for gathering detection data for a set of customers associated with the retail facility.

18. The system of claim 16 further comprising:
a smart detection engine, wherein the smart detection engine receives detection data from a set of detectors associated with the retail facility; and
analyzing the detection data to form the event data, wherein analyzing the detection data comprises generating the metadata describing the events associated with the retail facility.

19. The system of claim 16 further comprising:
a set of display devices associated with the retail facility, and wherein the set of display devices display customized marketing messages to customers, and wherein the optimized marketing model provides a set of optimized locations for the set of display devices.

20. The system of claim 16 further comprising:
a device for dispersing an odor-producing chemical into an area of the retail facility, wherein the odor-producing chemical is at least one of a naturally occurring chemical or an artificially created chemical, and wherein the optimized marketing model comprises an identification of a type of odor-producing chemical and a location for dispersing the odor-producing chemical into the area of the retail facility.
